(19) United States
(12) Patent Application Publication
(10) Pub. No.: US 2024/0206496 A1
(43) Pub. Date: Jun. 27, 2024

(54) Title of Invention PROCESS FOR PREPARING FROZEN CONFECTIONERY PRODUCTS

(71) Applicant: Conopco, Inc., d/b/a UNILEVER, Englewood Cliffs, NJ (US)

(72) Inventors: Visit MANOPAKARAT, Bangkok (TH); Cai YANG, Shanghai (CN)

(73) Assignee: Conopco, Inc., d/b/a UNILEVER, Englewood Cliffs, NJ (US)

(21) Appl. No.: 18/287,365

(22) PCT Filed: Apr. 21, 2022
(86) PCT No.: PCT/EP2022/060495

§ 371 Date: Oct. 18, 2023

(30) Foreign Application Priority Data
Apr. 23, 2021 (WO) PCT/CN2021/089445
Jun. 11, 2021 (EP) 21179009.2

(51) Int. Cl. A23G 9/28

(52) U.S. Cl. CPC A23G 9/288

(57) ABSTRACT

A process for producing frozen confectionery products, the process comprising: providing a source of a frozen confection to a chamber of a nozzle, the nozzle comprising an extrusion plate, wherein the extrusion plate defines one or more apertures in fluid communication with the chamber; wherein the apertures have a width of from 1 to 5 mm and a length of at least 10 mm; a first extrusion step of extruding the frozen confection from the chamber of the nozzle through the apertures of the extrusion plate, to produce extruded frozen confection having a direction of extrusion relative to the extrusion plate, the extrusion being carried out whilst the nozzle has a direction of movement having a component of movement in a direction parallel to the direction of extrusion wherein the component of movement is zero or in the same direction as the direction of extrusion; and followed by a second extrusion step of moving the nozzle with a direction of movement having a component of movement in a direction parallel to the direction of extrusion wherein the component of movement is in the opposite direction to the direction of extrusion is provided.

### TECHNICAL FIELD OF THE INVENTION

The present invention relates to a process for producing frozen confectionery products, more particularly a process for preparing frozen confectionery products having interesting decorative shapes with fine detail.

### BACKGROUND TO THE INVENTION

Ice cream cone products, such as Cornetto™ are popular and well-known. These products typically consist of a wafer cone filled with ice cream. Consumers are continually looking for new eating experiences, and conventional cone products may be perceived as somewhat old-fashioned and uninteresting. For example, they have a familiar shape with small flutes on the top of the ice cream.

It is known to fill containers, such as cones, by extruding ice cream from a nozzle which moves in the opposite direction relative to the direction of extrusion. For example, in the industrial production of cone products, such as Cornetto™, the cone is filled by a nozzle which is located inside the cone at the start of dispensing, and which moves up as the cone is filled. This ensures that the ice cream goes all the way to the bottom of the cone. U.S. Pat. No. 4,942,910 discloses a process for making shaped frozen confections in which a nozzle moves simultaneously in a circular path in the horizontal plane, and linearly in the vertical direction, so that the overall motion is in a spiral path. This produces a shaped frozen confection.

WO2013/149889 A1 also discloses a process for making shaped frozen confectionery by extrusion wherein the nozzle moves in the opposite direction to the direction of extrusion.

Nonetheless, there remains a need for an improved method for producing frozen confection products which have an attractive and appealing appearance, in particular with fine detail.

### BRIEF DESCRIPTION OF THE INVENTION

We have now devised a process that overcomes these problems.

The present invention provides a process for producing frozen confectionery products, the process comprising
providing a source of a frozen confection to a chamber of a nozzle, the nozzle comprising an extrusion plate, wherein the extrusion plate defines one or more apertures in fluid communication with the chamber; wherein the apertures have a width of from 1 to 5 mm and a length of at least 10 mm;
a first extrusion step of extruding the frozen confection from the chamber of the nozzle through the apertures of the extrusion plate, to produce extruded frozen confection having a direction of extrusion relative to the extrusion plate, the extrusion being carried out whilst the nozzle has a direction of movement having a component of movement in a direction parallel to the direction of extrusion wherein the component of movement is zero or in the same direction as the direction of extrusion; and
followed by a second extrusion step of moving the nozzle with a direction of movement having a component of movement in a direction parallel to the direction of extrusion wherein the component of movement is in the opposite direction to the direction of extrusion.

Thus, the process produces streams of extruded frozen confection that can produce attractive detailed formations with delicate designs. It has been found that, contrary to teachings in the prior art, such extrusion does not deform the streams if the nozzle is stationary or moving in the same direction as the direction of extrusion. Thus, extrusion may take place whilst the nozzle is e.g. moving towards a receptacle, providing potentially shorter times required for the process to take place. However, some movement of the nozzle in the opposite direction to the direction of extrusion is needed at the end, in order to produce the fine detail desired.

It is believed that the second step of moving the nozzle in the opposite direction provides the resulting streams of extruded with sharp pinnacles, providing the level of detail in the finished product.

The source of frozen confection is generally provided only when extrusion is desired, in order to maintain extrusion as frozen confection leaves the nozzle. Thus, the source of frozen confection is typically provided and maintained throughout the first extrusion step.

It is noted that ceasing the availability of the source of frozen confection, e.g. by closing a valve, will not immediately terminate the extrusion of frozen confection present in the chamber. There will be a period of time following stopping the source of frozen confection during which extrusion will continue due to residual pressure in the chamber, albeit at a reducing rate until extrusion eventually ceases.

Preferably the source of frozen confection is stopped before or during the second extrusion step, more preferably it is stopped during the second extrusion step. This has the effect of eventually terminating the flow of extrudable frozen confection whilst the nozzle is moving in the opposite direction to the flow of frozen confection. As a result, there has been found to be a gradual tapering in the streams of frozen confection as the flow of extruded frozen confection slows and eventually ceases. The movement of the nozzle in the opposite direction to the flow of frozen confection assists in the formation of the gradually reducing flow of extruded frozen confection into the sharp pinnacles, providing the level of detail in the finished product.

In one embodiment, the speed of the nozzle during the second step is increased during the second step. It has been found that as the flow of extruded frozen confection approaches zero, an increase in the speed of the nozzle in the direction opposite the flow of extrusion assists further in the formation of the sharp pinnacles.

In general, the apertures will have an elongate nature, having a well-defined width and length. For the avoidance of doubt, the reference to width and length refer to average figures, although in general the width and length will be consistent for each aperture. Preferably the apertures have a width of from 2 to 4 mm, such as about 3 mm. Preferably the apertures are arcuate, and more preferably are arranged concentrically around a central point in the extrusion plate. Such an arrangement provides a rose, tulip or spiral arrangement that is particularly visually appealing.

Preferably the frozen confection is extruded into a receptacle, such as a cup, tub or cone. The products produced may consist of ice cream or other frozen confection in receptacles such as cups, tubs or cones. The volume of frozen confection dispensed in each operation is preferably from 30 to 300 ml, preferably from 50 to 200 ml, such as about 100 ml.

Preferably the direction of extrusion is vertically downwards. Thus, when the frozen confection is extruded into a receptacle, the frozen confection moves downwards to a base of the receptacle.

In the first and second extrusion steps, the nozzle may also have a direction of movement that has a component of movement in a direction perpendicular to the direction of extrusion. This can be used, for example to provide additional effects, such as spiral movement of the nozzle.

In order to retain the shape formed during extrusion, the walls should not be so thin that they collapse under their own weight. Thus, high walls need to be thicker. Also, in order to retain the shape formed during extrusion, the frozen confection is preferably at a temperature of −5° C. or below on extrusion. Frozen confections which contain low amounts of fat are preferably extruded at lower temperatures, such as −7° C. or below.

In a preferred embodiment of the invention the extrusion plate of the apparatus has further openings between the apertures. These openings are connectable to means for forcing a gas from these further openings.

A single nozzle can be used to fill a single receptacle. Alternatively, an array of nozzles can be used to decorate the surface of a larger product (such as a 1 litre tub) with multiple portions.

The present invention is of particular utility in a factory environment, and therefore in general the process will involve a plurality of nozzles delivering frozen confectionery to a plurality of receptacles simultaneously. The process may be carried out in a very short time to facilitate efficient manufacture, e.g. less than 3 seconds. Thus, the invention provides for very finely detailed finished structures whilst also providing for efficient manufacturing. In order to facilitate efficient manufacture, the speed of the nozzle when moving is preferably in the range of from 0.5 to 3 m/s.

The process can produce very attractive decoration on the top surfaces of cone, cup and tub products. The shapes that can be produced consist of thin walls of frozen confection which are arranged to form shapes. The precise appearance is controlled by the size, shape and location of the apertures in the extrusion plate and the dosing volume and flow rate of the frozen confection. For example, for a given extrusion plate and speed of motion of the nozzle, increasing the flow rate of the ice cream results in a product having wider features.

The invention will now be illustrated, by way of example, and with reference to the following figures, in which:

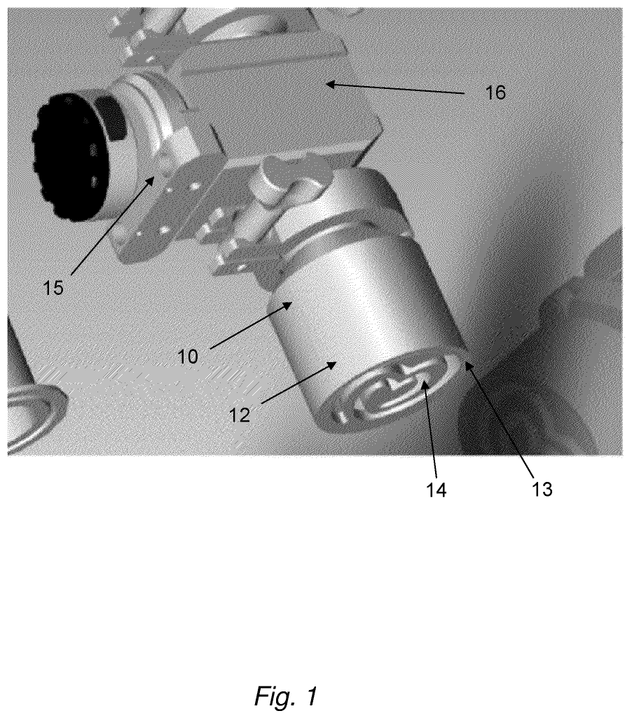

FIG. 1 is a perspective view of a nozzle for use in the present invention

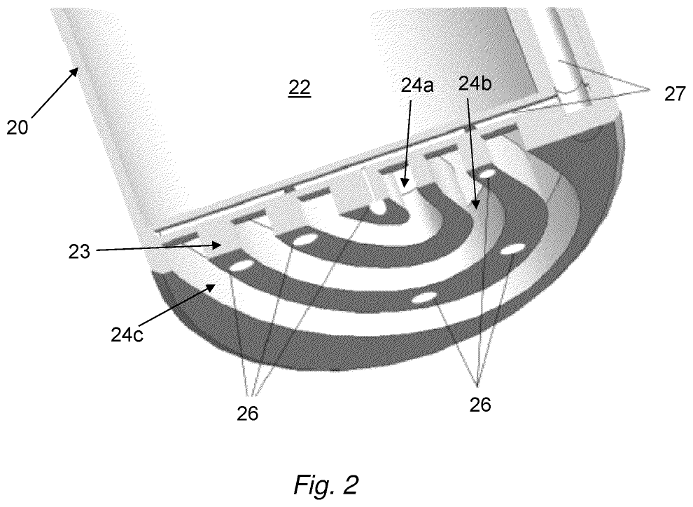

FIG. 2 is a perspective sectional view through a second nozzle for use in the present invention.

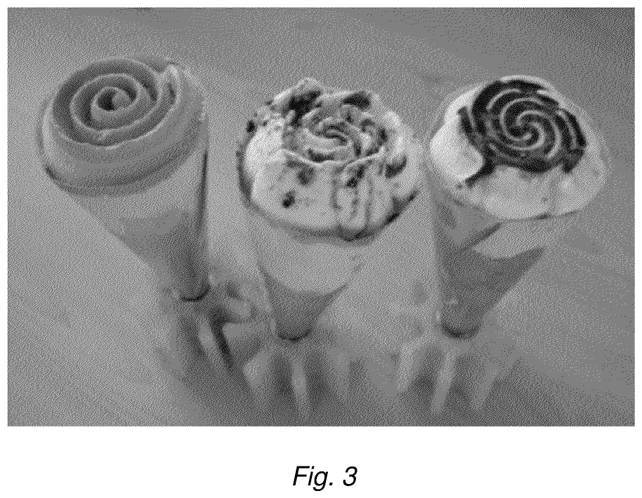

FIG. 3 is an image of examples of products which can be produced by the process of the present invention.

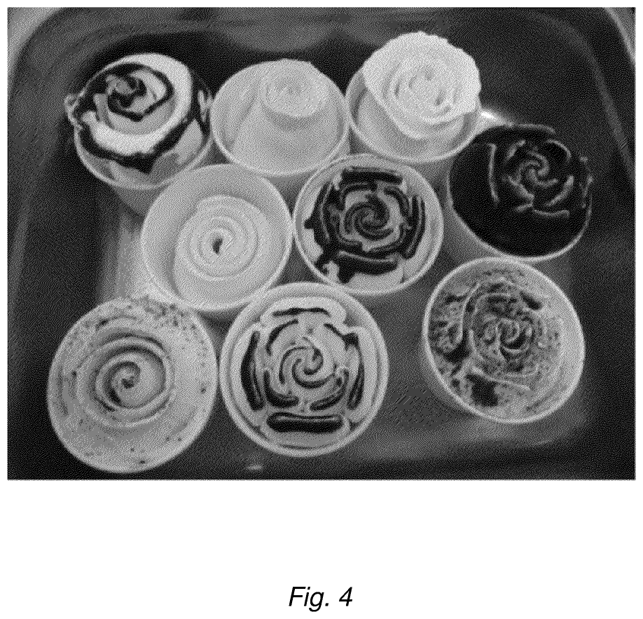

FIG. 4 is an image of further examples of products which can be produced by the process of the present invention.

Turning to the figures, FIG. 1 shows a nozzle 10 including a chamber 12 and an extrusion plate 13 with a single long, thin arcuate aperture 14 in a concentric manner in the form of a heart shape. Connected to the chamber 12 of the nozzle 10 is a manifold 16 comprising a valve 15.

In use, a source of frozen confection, e.g. ice cream, is provided to manifold 16 by an upstream supply (not shown) under pressure. The source of frozen confection flows to the chamber 12 of the nozzle 10 through the valve 15 when it is in its open position.

The nozzle 10 is then inserted into a receptacle, e.g. a cone, by moving in a vertically downwards direction such that the extrusion plate 13 is horizontal. The receptacle may have already been partially filled with frozen confection from a previous operation. As the nozzle moves downwards, the valve 15 is opened and frozen confection flows into the chamber 12 of the nozzle and begins to be extruded by being forced out of the aperture 14 in the extrusion plate 13. As a result, streams of frozen confection leave the extrusion plate 13 into the receptacle, possibly onto the surface of a previously deposited frozen confection.

Eventually, the nozzle 10 reaches its lowest point and extrusion continues whilst the nozzle 10 reverses direction to move vertically upwards. After a brief period of time the valve 15 is then closed, stopping flow of frozen confectionery into chamber 12. The nozzle continues to move upwards and extrusion of frozen confection continues due to residual pressure in the chamber 12. However, as the pressure drops so does the extrusion rate, resulting a decrease in the flow of frozen confection. This decrease in the flow results in a narrowing of the thickness of the streams of frozen confection and helps to provide pinnacles.

As the nozzle moves upwards, just prior to the extrusion ceasing, the upwards speed of the nozzle increases suddenly, which provides a final tearing of the stream in the frozen confection when it is at its narrowest, providing for a neat and fine decorative pinnacle feature to the streams.

FIG. 2 shows a second nozzle 20 for use with the present invention that includes a chamber 22 and an extrusion plate 23 with a plurality of arcuate apertures 24a, 24b and 24c arranged concentrically around a central point on the extrusion plate 23. Also provided in the extrusion plate 23 are further openings 26 that are in gaseous communication with channels 27.

In use, a source of frozen confection is provided to the chamber 22, which is extruded through the apertures in 24a, 24b, 24c in extrusion plate 23.

In operation, a gas, such as air, is also forced from the further openings 26 which serves to keep the various streams of the extruded confection separate from one another and allows for the production of particularly detailed products with delicate designs which are akin to the petals of a flower.

FIGS. 3 and 4 show products formed using the apparatus and the process of the invention. It can therefore be readily seen that the present invention is capable of providing extruded ice cream products with very fine and detailed decorative finishes to their surfaces.

1. A process for producing frozen confectionery products, the process comprising:
providing a source of a frozen confection to a chamber of a nozzle, the nozzle comprising an extrusion plate, wherein the extrusion plate defines one or more apertures in fluid communication with the chamber; wherein the apertures have a width of from 1 to 5 mm and a length of at least 10 mm;
a first extrusion step of extruding the frozen confection from the chamber of the nozzle through the apertures of the extrusion plate, to produce extruded frozen confection having a direction of extrusion relative to the extrusion plate, the extrusion being carried out whilst the nozzle has a direction of movement having a component of movement in a direction parallel to the direction of extrusion wherein the component of movement is zero or in the same direction as the direction of extrusion; and
followed by a second extrusion step of moving the nozzle with a direction of movement having a component of movement in a direction parallel to the direction of extrusion wherein the component of movement is in the opposite direction to the direction of extrusion.

2. A process according to claim 1, wherein the source of frozen confection is stopped before or during the second extrusion step,

3. A process according to claim 2, wherein the source of frozen confection is stopped during the second extrusion step.

4. A process according to claim 1, wherein the speed of the nozzle is increased during the second step.

5. A process according to claim 1, wherein the apertures have a width of from 2 to 4 mm, such as about 3 mm.

6. A process according to claim 1, wherein the apertures are arcuate, and preferably are arranged concentrically around a central point in the extrusion plate.

7. A process according to claim 1, wherein the frozen confection is extruded into a receptacle, such as a cup, tub or cone.

8. A process according to claim 1, wherein a gas, preferably air, is forced from further openings located between the apertures of the extrusion plate.

9. A process according to claim 1, wherein the frozen confection is extruded at a temperature of −5° C. or below.

10. A process according to preceding claim 1, wherein the speed of the nozzle when moving is in the range of from 0.5 to 3 m/s.
